(19) United States
(12) Patent Application Publication
(10) Pub. No.: US 2007/0131609 A1
(43) Pub. Date: Jun. 14, 2007

(54) Membrane structure and method of making

(75) Inventors: Vidya Ramaswamy, Niskayuna, NY (US); Milivoj Konstantin Brun, Ballston Lake, NY (US); Sergio Paulo Martins Loureiro, Saratoga Springs, NY (US); Anthony Yu-Chung Ku, Rexford, NY (US); Mohan Manoharan, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/297,776

(22) Filed: Dec. 8, 2005

(51) Int. Cl. B01D 29/00

(52) U.S. Cl. 210/490; 210/500.25; 210/500.27; 204/415

(57) ABSTRACT

A membrane structure is provided. A membrane structure has a top surface and a bottom surface. The membrane structure includes a plurality of sintered layers including an inner layer disposed between two outer layers. The membrane structure further includes a nonmonotonic gradient in pore size extending between the top surface and the bottom surface. A method of making a membrane structure is provided. The method includes the steps of providing at least one inner layer; providing a plurality of outer layers; and laminating the inner layer and the outer layers to obtain a membrane structure.

### BACKGROUND

The invention relates generally to a membrane structure. More particularly, the invention relates to a membrane structure with multiple functional and sensing layers. The invention also relates to a method for making a membrane structure.

Porous membrane structures have been extensively used in filtration, separation, catalysis, detection, and sensor applications. Generally, the exposed layer of a membrane is susceptible to damage during, and subsequent to, processing. Damage to the membrane, including defects, cracks, blockages, and so forth, can significantly degrade the performance of the membrane. There is a need for mesoporous and microporous membranes with uniform permeance across the membrane structure, and having a high resistance to structural damage. There is also a need for a robust method to make such membrane structures.

### SUMMARY OF THE INVENTION

The present invention meets these and other needs by providing a membrane structure, which is mechanically robust, and with an incorporated functionality.

Accordingly, one aspect of the invention is to provide a membrane structure. The membrane structure has a top surface and a bottom surface. The membrane structure includes a plurality of sintered layers including an inner layer disposed between two outer layers. The membrane structure further includes a nonmonotonic gradient in pore size extending between the top surface and the bottom surface.

A second aspect of the invention is to provide a method for making a membrane structure. The method includes the steps of providing at least one inner layer; providing a plurality of outer layers; and laminating the inner layers and the outer layers to obtain a membrane structure.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a membrane structure, according to one embodiment of the present invention;

FIG. 2 is a schematic representation of a membrane structure, according to another embodiment of the present invention;

FIG. 3 is a schematic representation of a gas separation assembly incorporating membrane structure of the invention, according to one embodiment of the invention;

FIG. 4 is a schematic representation of a filter incorporating membrane structure of the invention, according to one embodiment of the invention;

FIG. 5 is a flow chart of the method of making a membrane structure according to one embodiment of the invention; and

FIG. 6 is a scanning electron micrograph of an alumina membrane structure.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular aspect of the invention is said to comprise or consist of at least one of a number of elements of a group and combinations thereof, it is understood that the aspect may comprise or consist of any of the elements of the group, either individually or in combination with any of the other elements of that group.

As used herein, ‘membranes with nonmonotonic pore size’ refers to membranes wherein there is a non-uniform gradient in pore size between the bottom surface and the top surface of the membrane. In one embodiment, the outer portions of the membranes have larger pores than the pores of the inner portion of the membrane. In another embodiment, the outer portions of the membrane have finer pores than the pores of the inner portion of the membrane. “Sintered layers,” as used herein, is to be understood as meaning layers having the particular structure characteristics of material that has been consolidated via the sintering process; in particular, the structure contains compacted particles, with characteristic three dimensionally interconnected pores resulting from the spaces between the particles. As used herein, “permeance” refers to permeation rate. “Permselectivity” refers to preferred permeance of one chemical species through the membrane with respect to another chemical species.

Referring to the drawings in general, it will be understood that the illustrations are for the purpose of describing one embodiment of the invention and are not intended to limit the invention thereto.

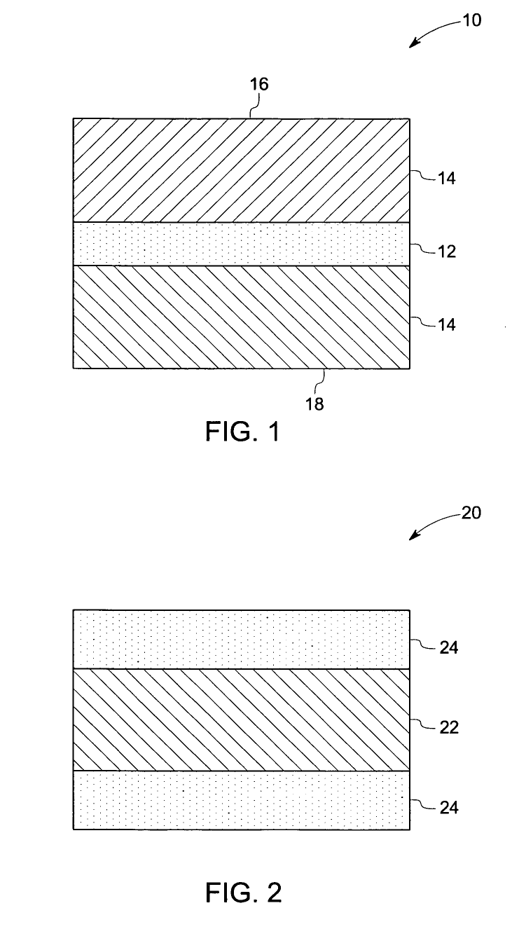

Schematic representations of a membrane structure according to two different embodiments of the present invention are shown in FIG. 1 and FIG. 2. The membrane structure 10 of FIG. 1 includes an inner layer 12 disposed between two outer layers 14. In some embodiments, the membrane structure may include more than one inner and outer layers. Typically, one or more of the layers are sintered layers having three dimensionally connected pores. The membrane structure includes a nonmonotonic gradient in pore size extending between the top surface 16 and the bottom surface 18. This nonmonotonic gradient in pore size gives distinct advantages to a membrane structure and enables different functionalities that would not be possible otherwise. The pore wall chemistry and the pore dimension relative to the permeating species typically control the diffusion of species through a membrane. By introducing a nonmonotonic gradient in pore size and by controlling the pore dimensions within different regions of the membrane structure, it may be possible to control the diffusion of different species through the membrane structure. Different aspects of the advantages of introducing nonmonotonic distribution of porosity will be discussed in the following paragraphs with respect to specific examples.

In some embodiments, as shown in the membrane structure of FIG. 1, the median pore size of the inner layer is less than the median pore size of each of the two outer layers. The outer layers having bigger pores than the inner layers and having coarse microstructure may facilitate certain functionalization processes, especially those related to wall surface functionalization and pore functionalization. For example, the selective deposition of a material in the outer layers may be accomplished by using nanoparticles of the desired material that have a diameter smaller than the pore diameter of the outer layer, but larger than the pore diameter of the inner layer. Alternately, a deposition process that involves heterogeneous nucleation and growth on the pore walls may result in a higher volumetric loading in the inner layer. In embodiments, where different layers include different materials, layer selective functionalization may also be achieved. For example, nucleation may be more favorable on only one of the layers or functionalization may take place by a reaction with the material of one of the layers. The outer layers having larger pores than the inner layers protect the active inner membrane layer without sacrificing flux, make the membrane structure more robust, and less prone to warping during processing.

The pore size of individual layers within the membrane structure is chosen based on desired configuration and the end use application. In some embodiments, the inner layer has a median pore size of up to about 300 nanometers. In other embodiments, the median pore size of the inner layer is in a range from about 1 nanometer to about 100 nanometers. In some other embodiments, the median pore size of the inner layer is in the range from about 1 nanometer to about 20 nanometers. In one embodiment, the outer layers have a median pore size of at least about 100 nanometers. In another embodiment, the outer layers have median porosity in the range from about 100 nanometers to about 10 micrometers. In these embodiments, the pore size of the outer layers is chosen so that they do not hinder the permeance and permselectivity of the species through the membrane structure.

Precise pore size control within each of the layers of the membrane structure is highly desirable for filtration and separation applications. The membrane structure of the invention is characterized by a narrow pore size distribution. It is possible to control the pore size distribution to a minimal by the process of the invention as will be discussed in the method embodiments.

The membrane structure is thick enough for mechanical robustness, but not so thick as to impair permeability. The individual layers are configured to have different thicknesses depending on the end use application. In one embodiment, the inner layer has a thickness in the range from about 30 nanometers to about 20 micrometers. In another embodiment, the inner layer has a thickness in the range from about 30 nanometers to about 4 micrometers. In one embodiment, each of the outer layers has a thickness of at least about 5 micrometers. In another embodiment, each of the outer layers has a thickness of at least about 100 micrometers.

In some embodiments, such as a membrane structure 20 shown in FIG. 2, the median pore size of the inner layer 22 is greater than the median pore size of each of the two outer layers 24. Typically, layers with smaller pore size are made thinner in order to maintain good permeance. Accordingly, in such embodiments, the inner layer 22 has a thickness that is greater than a thickness of each of the outer layers 24. The bigger pore sizes of the inner layer facilitate easy functionalization of the inner layers to achieve a specific reactivity. The benefit of such a membrane structure is an increased membrane residence time. For example, the structure may be suitable for filtration or separation applications, where the outer layers perform size-based separation or filtration and the inner layer does a catalytic conversion. An example is the separation of a 3-component mixture in which two components can pass through the outer layers. The inner layer may be functionalized in such a way as to catalytically react with one of the components that passes through the outer layers.

In all the above embodiments, the membrane structure may further include additional protective layers disposed over each of the outer layers. These protective layers are designed to protect the membrane structure from wear and tear during processing, handling or operation. The thickness and porosity of the protective layer is chosen so as not hinder the performance of the membrane structure. Protective layers may be made of a ceramic or a metal, and may have pores larger than the interior layers.

Different layers within the membrane structure may have different porosity. In one embodiment, the membrane structure has a porosity volume fraction of at least about 1%. In another embodiment, the membrane structure has a porosity volume fraction of at least about 10%. In another embodiment, the membrane structure has a porosity volume fraction of at least about 20%. In yet another embodiment, the membrane structure has a porosity volume fraction of at least about 25%. Porosity as referred to herein is the porosity averaged over the entire membrane structure. The membrane structure may include one or more of non-porous layers in addition to the porous layers maintaining the overall porosity within the desired limits. For example, a separation layer of non-porous cross-linked polyvinyl alcohol layer of suitable thickness may be used in conjunction with the membrane structure.

In some embodiments, at least one of the outer layers includes an electrically conductive material. Electrically conductive outer layers facilitate easy coupling of the membrane structure to an electrical circuit in such embodiments such as in a sensor. Electrically conductive outer layers also facilitate electro deposition of additional layers on the outer layers. Some examples of suitable electrically conductive materials include, but are not limited to, semiconductor oxides such as tin oxide, titanium oxide, vanadia, or metals.

In some embodiments, it may be desirable to sense the membrane performance optically. Optical transparency may also be desirable for photonic applications of the membrane structures. Accordingly, in some embodiments, at least one of the membrane outer layers is transparent to light. In one embodiment, at least one of the outer layers transmits at least about 5% of incident light. In another embodiment, at least one of the outer layers transmits at least about 10% of incident light.

In some embodiments, at least one of the layers includes a catalytic material. For example, by utilizing a catalytic coating or a catalytic layer within the membrane structure, it is possible to combine membrane separation with catalytic reaction to achieve high efficiency fluid mixture separation. The catalyzed reaction may be used to reduce the concentration of one or more of the reaction products within the membrane structure, hence increasing the conversion efficiency. Catalytic materials may also be included in the membrane structure for microreactor or sensor applications. Some examples of catalysts include, but are not limited to, platinum, palladium, copper, transition metals and their oxides, copper oxide, ceria, perovskites, zinc oxide, alumina, combinations thereof, or alloys thereof. One skilled in the art would know how to choose a catalyst material based on the desired reaction and given working environment, then dispose the desired catalyst in the outer layer.

The catalysts may be disposed onto the structure by a number of coating techniques. They may be deposited by a physical vapor deposition or by chemical means. Examples of physical vapor deposition include, but are not limited to, evaporation, e-beam deposition, ion beam deposition, atomic layer deposition, or a suitable combination of these techniques. The catalyst may also be disposed into the membrane structure by means of chemical vapor deposition. The pores of the membrane structure may also be filled with a catalyst by simple capillary filling, or by spray coating. In such embodiments, the catalyst to be disposed may be taken as a sol, a solution or a gel. In some embodiments, the pore walls of one or more layers are coated with a catalyst. In some other embodiments, a catalyst layer is disposed within the membrane structure.

The material of the inner and the outer layers are chosen based on the end use application. The inner and the outer layers may include different materials. In an exemplary embodiment, the membrane structure includes a ceramic. Non-limiting examples of ceramics are oxides, carbides, nitrides, borides, and silicides. Examples of suitable ceramics include, but not limited to, aluminum oxide, silica, silicate, rare-earth oxide, titania, zirconia, lanthana, yttria stabilized zirconia, a perovskite, a spinel, vanadia, and ceria. In some embodiments, the ceramic may include a suitable dopant. Ceramic materials have the advantages of thermal, chemical stability, good erosion resistance, and high pressure stability. Ceramic materials make the membrane structures of the invention thermally and chemically stable to withstand prolonged exposure to pressure or temperature differences that may be present in a gas separation or a sensor assembly. The membrane structures of the invention are designed to be mechanically robust. The membrane structure has sufficient mechanical strength and facilitates easy handling during processing and operation.

In some embodiments, the membrane structure includes a metal. A pure metal or a metal alloy may be used. The metal may be applied on the membrane layers as a dispersed particulate, or a continuous coating, or a metal layer may be inserted into the membrane structure. In some embodiments, the membrane pore walls may be coated with a metal. The metal may be disposed into the membrane structure by any known coating technique including exposing the structure to a suspension of metal particulates, electroless deposition or electroplating, or chemical vapor deposition or physical vapor deposition. In some embodiments, the metal is a platinum group metal. Platinum group metals such as platinum, palladium, rhodium, ruthenium, osmium, and iridium show good hydrogen permeability and may be used where hydrogen separation is required. In one embodiment palladium with copper, gold or silver is used. In another embodiment, palladium with ruthenium, osmium, nickel, platinum, or a combination of these is used. In some embodiments, transition metal elements such as iron, nickel, cobalt, or copper may be included in the membrane structure. Many transition metal complexes show selective interaction with molecular oxygen involving reversible chemisoption and are suitable for oxygen separation. These complexes may include a transition metal ion and a polydentate ligand. Some examples of suitable complexes are Co or Ni or Cu embedded in polyphyrins or oximes, to which axial bases such as nitrogen or sulphur are attached.

In some embodiments a mesoporous ceramic material may be included within the pores of a layer. Some or all of the pores may be filled depending on the requirement. Examples of suitable mesoporous materials include, but are not limited to silica, zirconia, titania, alumina, and perovskites. More than one mesoporous material may be incorporated into the membrane structure.

In some embodiments, the membrane structure includes an organic material. The organic material may include a polymer, an oligomer, or a monomer. Suitable polymers that may be used include, but are not limited to, polysulphones, polyamides, cross-linked polyimides, polyether ketones, polyetherimides, silicone rubber, nitrile rubber, neoprene rubber, silicone, polycarbonate, polyarylene, polyphenylene ether, polyolefin elastomer, polybutadiene, vinyl polymers, or other thermoplastic polymers, combinations thereof, and block copolymers of these. These polymers may be used to achieve specific functionalities. For example, silicone rubber is very effective in removing volatile organic components such as toluene, methanol, methylene chloride, and acetone from gas streams.

Alternatively, the membrane layers may be functionalized with a suitable functional group to achieve specific functional properties. The functional group may be acidic, basic, an amine, a hydroxyl, a carbonyl, a carboxyl, a mercapto group, a vinyl group, an alkyl, a fluoroalkyl, a benzyl, or an acryl group. These functional groups alter the surface properties of the membrane materials and impart specific properties to the membranes. For example, the functional groups may be used to change the wettability of the membrane pore surfaces to control the flow of fluid through the membrane. Functionalizing the pore surfaces is especially useful for biological or biomedical applications where the membranes desirably be hydrophilic, hydrophobic, lyophobic or lyophilic. The functional groups may be used to control the flow of specific chemical or biological species through the membrane. Specific functional groups may be used to control the attachment of cells or proteins to the membrane structure. For example, the functional groups may also be used to make the membrane structure biocompatible for biomedical applications. The functional groups may be disposed onto the membrane structure by any known coating technique. In some embodiments, the functional group may be attached to the selected regions of the layers by exposing the layers to solutions or vapor or ions including the desired species. Pretreatment of the layers to enhance the adhesion of the functional groups and masking of regions to be protected during coating may be required.

In some embodiments, the membrane structure includes a composite material. The composite may include a ceramic-organic, a ceramic-metal or a ceramic-ceramic composite. Any ceramic, organic material, and a metal or a metal alloy including those listed above may be used in the composite.

The membrane structure of the invention finds a number of applications. In one aspect, the invention provides a separation assembly including the membrane structure. The membrane structure in certain embodiments of the invention may be capable of molecular sieving suitable for purification of sub quality natural gas, air separation, NOₓ separation, oxygen separation, or hydrogen recovery from processing gases or feedstock. In one embodiment, the membrane structure of the invention may be used for separation of hydrogen from nitrogen, argon, carbon dioxide, or methane. In another embodiment, the membrane structure of the invention may be used for separation of volatile organic components from air streams. For such applications, a suitable metal or a polymer coating may be applied on one or more layers of the membrane structure. Alternatively, a metal or a polymer layer may be used in conjunction with the membrane structure.

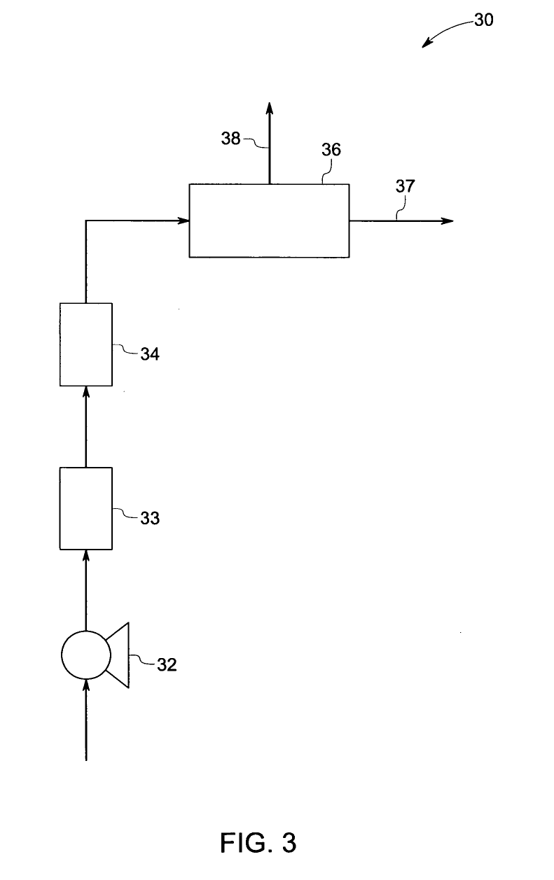

FIG. 3 shows a schematic representation of a simple gas separation unit 30 according to one embodiment of the invention. The unit 30 includes a compressor 32, a coalescing filter 33 and a pre-heater unit 34 connected to a membrane separation unit 36. Air under pressure flows first through the coalescing filter 33 and then through the pre-heater unit 34 before reaching the membrane separation unit 36. The coalescing filter may be used to remove oil or water droplets or particulate solids from the feed. The membrane separation unit includes one or more of membrane structure of the invention configured to remove a desired component from the air mixture. The desired component passes through outlet 37, leaving the waste permeate gases through outlet 38. The membrane separation unit may include additional heaters or additional filters.

The membrane structure may be used as a liquid-liquid separation assembly. For such applications, the membrane structure may be combined with other porous or non-porous separation layers if needed. The pore structure and thickness of each of the layers may be adjusted depending on the requirement. In some embodiments, the membrane structure may be a membrane structure in a separation assembly that also includes a reactor component to prevent fouling.

In one embodiment, the membrane structure is part of a filtration assembly. By controlling the pore dimensions of the layers, the membrane structure of the invention may be used for microfiltration to filter out solid particles with dimensions less than about 10 micrometers, or for ultrafiltration to filter out particles with dimensions down to about 50 nanometers such as separation of macromolecules and bacteria. By choosing the pore dimensions of the layers to very small sizes, it is possible to use these membrane structures for hyperfiltration to filter out still smaller units such as sugars, monomers, aminoacids, or dissolved ions by reverse osmosis. Accordingly in one embodiment, the membrane structure is a part of a filter usable in food, pharmaceutical, and industrial applications. In one embodiment, the membrane structure is a part of a bio-separation or reaction assembly. The pore size and thickness of the membrane layers are chosen depending on the sizes of the species to be separated. In another embodiment, the membrane structure is a part of a protein purification unit.

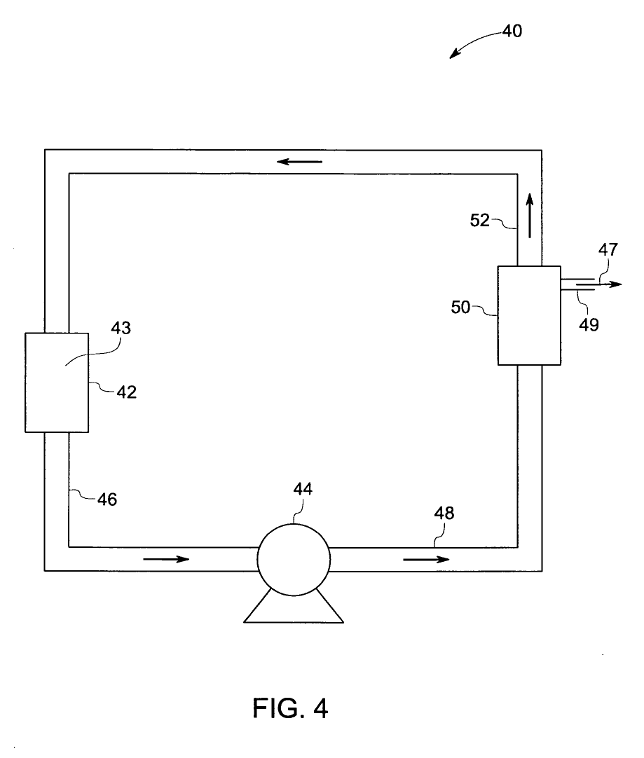

FIG. 4 shows a schematic representation of a simple filter unit 40 according to one embodiment of the invention. The unit 40 includes a feed tank 42 used for storing the liquid medium containing the material to be separated. The circulation of the feed 43 is controlled by the pump 44 that draws the feed 43 through lines 46 and 48 into a membrane filter assembly 50. The membrane filter assembly 50 includes one or more of the membrane structure of the invention configured to filter out a specific component from the feed. The desired component ‘filtrate’ 47 passes through outlet 49, while the retentate 52 may be removed or returned to the feed tank 42.

In one embodiment, the membrane structure is part of a reactor assembly. In another embodiment, the membrane structure is capable of reactive separation wherein the membrane structure is a reactor that also separates one of the products. In an exemplary embodiment, the membrane structure is a part of a chemical microreactor assembly that generates hydrogen fuel from liquid sources such as ammonia. In such embodiments, suitable hydrogen perselective catalysts are used in the membrane structure.

In one embodiment, the membrane structure is part of a sensor assembly. In such embodiments, the membrane layers may be functionalized with functional groups as discussed above, to incorporate reversible changes within the membrane structure. Examples of reversible changes include, but not limited to, chemical reactions such as ionization, oxidation, reduction, hydrogen bonding, metal complexation, isomerization, and covalent bonding. These changes may be utilized to detect a chemical or a biological species, or to detect change in temperature, pH, ionic strength, electrical potential, light intensity or light wavelength. The use of membrane structures for sensor applications is expected to enhance the performance of detection because of their high surface to volume ratio. In all the above embodiments, the membrane structure of the invention permits greater flexibility in materials selection and placement.

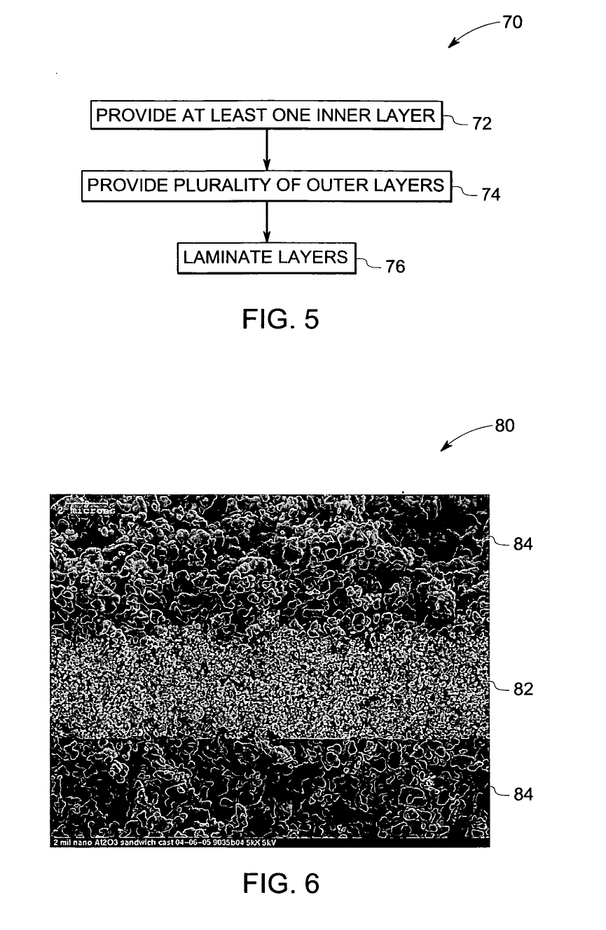

Another aspect of the invention is to provide a method for preparing a membrane structure. The method of making a membrane structure is shown as a flow diagram in FIG. 5. The method 70 begins with step 72, wherein at least one inner layer is provided. In step 74, a plurality of outer layers is provided. In step 76, the inner and the outer layers are laminated to obtain a membrane structure. The sequence of stacking of the layers depends on the structure of the final membrane structure desired.

Any fabrication technique suitable for fabricating porous layers may be used to fabricate the layers. In a typical fabrication technique for ceramic layers, a slurry including the ceramic powder of the desired material is prepared. The slurry may include a binder and a curing agent. The binder may be any binder compatible with the material system. In some exemplary embodiments, a silicone binder is used. The amount of powder in the slurry is generally adjusted to have the best Theological character. Further additive agents may be mixed into the slurry, such as a dispersing agent for improving the dispersibility and to prevent rapid settling, and a platicizer for improving the binding force between the binder and the ceramic particles and to lower the risk of cracks. According to particular embodiments, the method includes the additional optional steps of deagglomeration and deairing of the slurry for better results. Achieving a slurry without agglomerates may be required to achieve narrow pore size distribution within the layers. Typically a layer is formed on a substrate by applying the slurry on the substrate. Any technique known in the art for preparing layers may be used for forming the layer. Non-limiting examples of useful formation techniques include, but are not limited to, spraying, screen printing, ink-jet printing, casting, wire-bar coating, extrusion coating, gravure coating, roll coating, and combinations thereof. In some exemplary embodiments, a casting technique, such as tape casting, is used. Tape casting proves useful for making large area thin ceramic sheets with controlled thickness and porosity. A variety of substrates may be used for making the film, including, but are not limited to plastic, mylar, glass, mica, metal substrates, and ceramic substrates. The process may include an intermediate curing process to remove organic binders and solvents. After curing the layer is removed from the substrate to obtain a free-standing layer.

After solvent evaporation, the layers are stacked together in the desired ordered and laminated. Typically, lamination is done by applying a suitable load at a slightly elevated temperature.

The process may further include a sintering step in order to densify the layers. Exemplary sintering techniques may involve heating at a specified temperature for a specified duration, or microwave irradiation, or electron beam irradiation, or UV light exposure, or a combination of those. The porosity, pore size, and pore size distribution is controlled by the particle sizes of starting material. A layer with fine pore size may be obtained by casting particles with fine particle sizes. A layer with coarse pore size may be obtained by casting particles with bigger particle sizes. It is desirable to start with particles of uniform particle sizes in order to achieve uniform pore structure with minimal pore size distribution. Defect free layers with desired porosity may be obtained by a precise control of sintering conditions.

The embodiments of the process of the invention may be directly applied to fabricate membrane structures with layers of dissimilar materials and a range of pore sizes and porosity. This is a scalable process for making large area porous membranes with multiple porosity levels. In addition, the embodiments of the method allow several options to functionalize each of the layers comprising the membrane structure prior to, during, or after processing.

The membrane structure and method of making the membrane structure of the present invention is designed to meet fundamentally different design requirements from those applied to prior art membrane structures. The membrane structure of the invention have nonmonotonic gradient in porosity across the surface of the membrane structure. The advantages of nonmonotonic gradient in porosity are already discussed. The membrane structure includes multiple sintered layers with different porosity, wherein each individual layer is characterized by substantially uniform, three-dimensionally connected high-density pores. The pores within each individual layer are interconnected and thus provide high flux for separation or filtration applications and provide high surface area for sensor or reactor applications.

The following example serves to illustrate the features and advantages offered by the present invention, and not intended to limit the invention thereto.

### EXAMPLE

The following example describes the preparation method for making an alumina membrane structure.

A slurry consisting of nanoparticles of alumina having a median particle size of 200 nm, a solvent (a mixture of xylene and ethanol), a dispersant (Emphos, ps236) a binder (Butvar B76) and a plasticizer (G-50) is cast as a thin tape of about 25 micrometers to about 250 micrometers onto a sheet of Mylar using conventional tape casting techniques. This is followed by a thick tape (>500 micrometers) cast from a slurry consisting of micron-sized particles of alumina having median particle size of 3 microns, a solvent, a binder and a plasticizer. Upon solvent evaporation, the two-layered tape is peeled from the Mylar. A membrane structure is made by placing the thin layers face to face in a lamination press and applying a compressive stress of 20 megapascals at a temperature of 100° C. The laminated structure is then sintered at 1200° C. to obtain mechanical strength and optimal porosity. FIG. 6 is a scanning electron micrograph 80 of an alumina membrane structure prepared according to the procedure described above. The micrograph shows a nanoporous layer 82 sandwiched between two microporous membranes 84.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A membrane structure having a top surface and a bottom surface, the membrane structure comprising:
a plurality of sintered layers comprising an inner layer disposed between two outer layers;
wherein the membrane structure further comprises a nonmonotonic gradient in pore size extending between the top surface and the bottom surface.

2. The membrane structure of claim 1, wherein the sintered layers comprise a plurality of pores, the pores having a three-dimensional connectivity.

3. The membrane structure of claim 1, wherein the median pore size of the inner layer is less than the median pore size of each of the two outer layers.

4. The membrane structure of claim 3, wherein the inner layer has a median pore size of up to about 300 nanometers.

5. The membrane structure of claim 4, wherein the median pore size is in a range from about 1 nanometer to about 100 nanometers.

6. The membrane structure of claim 5, wherein the median pore size is in the range from about 1 nanometer to about 20 nanometers.

7. The membrane structure of claim 3, wherein the inner layer has a thickness in the range from about 30 nanometers to about 20 micrometers.

8. The membrane structure of claim 7, wherein the inner layer has a thickness in the range from about 30 nanometers to about 4 micrometers.

9. The membrane structure of claim 3, wherein the outer layers have a median pore size of at least about 100 nanometers.

10. The membrane structure of claim 9, wherein the outer layers have median pore size in the range from about 100 nanometers to about 10 micrometers.

11. The membrane structure of claim 3, wherein each of the outer layers has a thickness of at least about 5 micrometers.

12. The membrane structure of claim 3, wherein each of the outer layers has a thickness of at least about 100 micrometers.

13. The membrane structure of claim 1, wherein at least one of the outer layers comprises an electrically conductive material.

14. The membrane structure of claim 1, wherein at least one of the outer layers transmits at least about 5% of incident light.

15. The membrane structure of claim 1, wherein at least one of the layers comprises a catalytic material.

16. The membrane structure of claim 1, wherein the membrane structure has a porosity volume fraction of at least about 1%.

17. The membrane structure of claim 1, wherein the membrane structure has a porosity volume fraction of at least about 25%.

18. The membrane structure of claim 1, wherein the inner layer comprises an inner layer material and at least one outer layer comprises an outer layer material, and wherein the inner layer material is different from the outer layer material.

19. The membrane structure of claim 1, wherein the membrane structure comprises a ceramic.

20. The membrane structure of claim 19, wherein the ceramic comprises at least one selected from the group consisting of oxides, carbides, nitrides, borides, and silicides.

21. The membrane structure of claim 20, wherein the ceramic comprises at least one selected from the group consisting of aluminum oxide, silica, silicate, rare-earth oxide, titania, zirconia, lanthana, yttria stabilized zirconia, a perovskite, a spinel, vanadia, and ceria.

22. The membrane structure of claim 19, wherein the ceramic further comprises a dopant.

23. The membrane structure of claim 19, wherein the ceramic further comprises a coating.

24. The membrane structure of claim 23, wherein the coating comprises a functional group.

25. The membrane structure of claim 24, wherein the functional group is at least one selected from the group consisting of a acid, a base, an amine, a carboxyl, a hydroxy, a carbonyl, a vinyl, a mercapto, an alkyl, a fluoroalkyl, an acryl, a benzyl group, and a combination thereof.

26. The membrane structure of claim 1, wherein the membrane structure comprises a metal.

27. The membrane structure of claim 26, wherein the metal comprises a transition metal element and combinations thereof.

28. The membrane structure of claim 26, wherein the metal comprises at least one selected from the group consisting of a platinum group metal, iron, nickel, cobalt, copper, combinations thereof, and alloys thereof.

29. The membrane structure of claim 1, wherein the membrane structure comprises an organic material.

30. The membrane structure of claim 29, wherein the organic material comprises a polymer.

31. The membrane structure of claim 30, wherein the polymer is one selected from the group consisting of polysulphones, polyamides, cross-linked polyimides, polyether ketones, polyetherimides, silicone rubber, nitrile rubber, neoprene rubber, silicone polycarbonate, polyolephin elastomer, polybutadiene, vinyl polymers, and combinations thereof.

32. The membrane structure of claim 1, wherein the membrane structure comprises a composite material.

33. The membrane structure of claim 32, wherein the composite material comprises a ceramic material and an organic material.

34. The membrane structure of claim 32, wherein the composite material comprises a ceramic material and a metal.

35. A separation assembly comprising the membrane structure of claim 1.

36. A filtration assembly comprising the membrane structure of claim 1.

37. A reactor assembly comprising the membrane structure of claim 1.

38. A sensor assembly comprising the membrane structure of claim 1.

39. The membrane structure of claim 1, wherein a median pore size of the inner layer is greater than the median pore size of each of the two outer layers.

40. The membrane structure of claim 39, wherein the inner layer has a thickness that is greater than a thickness of each of the outer layers.

41. The membrane structure of claim 40, further comprising protective layers disposed over each of the outer layers.

42. A membrane structure comprising:
a sintered inner layer disposed between two sintered outer layers;
wherein the sintered inner layer has a median pore size in the range from about 1 nanometer to about 20 nanometers, and a thickness in the range from about 30 nanometers to about 4 micrometers;
wherein the sintered outer layers each have a median pore size of at least about 100 nanometers and a thickness of at least about 100 nanometers; and
wherein the membrane structure comprises a ceramic material.

43. A method comprising:
providing at least one inner layer;
providing a plurality of outer layers; and
laminating the inner layer and the outer layers to obtain a membrane structure.

44. The method of claim 43, wherein providing the plurality of layers comprises tape casting of a slurry comprising a plurality of particles.

45. The method of claim 43, wherein laminating the plurality of layers further comprises assembling the layers and applying a load to the assembled layers.

46. The method of claim 44, wherein laminating the plurality of layers further comprises sintering.
